(19) United States
(12) Patent Application Publication
(10) Pub. No.: US 2004/0047400 A1
(43) Pub. Date: Mar. 11, 2004

(54) Receiver and method for improving synchronisation

(76) Inventors: Jari Iinatti, Oulu (FI); Matti Latva-Aho, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/362,658

(22) PCT Filed: Aug. 29, 2001
(86) PCT No.: PCT/FI01/00753

(30) Foreign Application Priority Data
Aug. 30, 2000 (FI) 20001912

(51) Int. Cl. H04K 1/00

(52) U.S. Cl. 375/143

(57) ABSTRACT

The invention relates to a receiver and method for improving synchronisation. In the solution of the invention, a signal is received and filtered by a matched filter (500) or processed by a correlator (520). Two or more consecutive samples in the output of the matched filter or correlator are combined and re-sampled in such a manner that the re-sampling is done over as many samples as the combination, and one or more correlation peaks are found in the combined samples.

### FIELD OF THE INVENTION

The invention relates to a receiver and a method for performing synchronisation in the receiver. The invention relates especially to a spread-spectrum receiver.

### BACKGROUND OF THE INVENTION

In telecommunications systems, a receiver must synchronise itself with a received signal so as to receive the signal correctly. In typical telecommunications systems, it is possible to define several different levels of synchronisation: carrier, symbol, bit, frame and network synchronisation. Spread-spectrum systems also require code synchronisation in which the code phase of the received signal and the code phase of a spreading code generated in the receiver are made congruent. This is essential, because if the code phases are not in-phase, the demodulation and detection of the received signal is not possible.

Code synchronisation can be divided into two different phases, rough and fine synchronisation. In the first phase (code acquisition), the difference in the code phases is made smaller than one code bit, i.e. chip (±0.5 chip). The latter phase concerns code tracking, in which the aim is to make the code difference as small as possible and to maintain it small.

The synchronisation should take place as quickly as possible especially in the beginning of a telecommunications connection, so that a new user would quickly be able to use network services. A mean acquisition time is generally used as a measure for the performance of code synchronisation.

Telecommunications connections are susceptible to numerous disturbances. One typical phenomenon especially in radio systems is multipath propagation of a transmitted signal. During synchronisation, the delays of the different paths and the complex gains of the signal which propagated in a multipath channel must be found. This is not a simple task due to the time-varying nature of the channel and the errors caused by interference. Interference, multipath propagation and signal fading make synchronisation difficult, reduce detection probability and increase the probability of false alarms. In connection with synchronisation, false alarms refer to the fact that synchronisation has failed. False alarms increase the synchronisation time.

The first phase of synchronisation (code acquisition) can according to prior art be done in may ways. Typically, either active or passive correlation is used, i.e. either a correlator or a matched filter, of which the latter is faster. Let us assume that the code length is q chips. In synchronisation, it is then necessary to examine every code phase difference of q possible phase differences between the code of the received signal and the receiver code. If the codes are in-phase, the output of the matched filter is a high value, i.e. peak, otherwise the output is approximately zero. This thus concerns the calculation of code auto-correlation. A threshold detector is typically connected to the output of a matched filter to detect the peak, i.e. synchronisation.

FIG. 1 illustrates a synchronisation solution of prior art. The received signal r(t) is forwarded to a matched filter 100, the output of which is in proportion to the auto-correlation function of the used code. An envelope detector 102 is located in the output of the matched filter. From the envelope detector the signal is forwarded to a first threshold detector 104, for which a suitable threshold value Tₕ is calculated on the basis of the received signal in a calculation unit 106. The output of the threshold detector is the value 1, if the threshold is exceeded, and otherwise 0. If the threshold is exceeded when the auto-correlation delay is 0, the detection is a correct detection, whose probability is P_{d}, otherwise it is a false alarm, whose probability is P_{fa}. A (symbol-level) post detection integration (PDI) 108 and a second threshold detector 110 can follow the first threshold detector. PDI improves the signal-to-noise ratio. When a peak has been found, another sweep must yet be made over the multipath spread to specify the location of the peak and determine its strength.

A multipath propagated channel presents the problem in particular that the individual energies of the paths are low. This leads to a long synchronisation time, especially if multiple access interference is present. FIG. 2 illustrates an example of a situation in which two multipath propagated signal components 200, 202 have been received. The horizontal axis shows the time and the vertical axis the power. If the code length is N and the chip length is Tc, then according to the figure the received paths repeat at an interval of a code period NTc. Inside the code period NTc, there are two peaks in which the synchronisation may take place.

To utilize multipath propagated components in synchronisation, a method has been developed, in which method chip-level integration is performed, i.e. in which consecutive samples are taken from the output of a matched filter and combined by means of filtering, for instance FIR filtering. The method is described in the publication J. Iinatti, M. Latva-aho: Matched filter acquisition in fixed multipath channel, IEEE Intl. Symp, on Personal, Indoor and Mobile Radio Communication, PIMRC'98, 1998, Boston, Mass., U.S.A., Proceedings Vol III, pp. 1501 to 1505. A drawback in the disclosed method is that the time window required by the second sweep is wider than in other known methods.

### BRIEF DESCRIPTION OF THE INVENTION

It is an object of the invention to provide an improved method for performing synchronisation and a receiver to which the method can be applied. This is achieved by a method for improving synchronisation, which comprises receiving a signal, filtering the received signal by a matched filter, combining and re-sampling two or more consecutive samples in the output of the matched filter in such a manner that the re-sampling is done over as many samples as the combining, and finding one or more correlation peaks in the combined samples.

The invention also relates to a method for improving synchronisation, which comprises receiving a signal, processing the received signal by a correlator, combining and re-sampling two or more consecutive samples in the output of the correlator in such a manner that the re-sampling is done over as many samples as the combining, and finding one or more correlation peaks in the combined samples.

The invention also relates to a receiver which comprises a matched filter for filtering a received signal, and means for sampling the output signal of the matched filter, means for combining two or more consecutive samples. The invention also relates to a receiver which comprises a correlator (500) for correlating a received signal, and means (502) for sampling the output signal of the correlator, means (506) for combining two or more consecutive samples.

The receiver of the invention comprises means for re-sampling a summed signal over as many samples as were combined, and means for finding one or more correlation peaks in the combined and re-sampled signal.

The invention is based on the fact that because the re-sampling is done using the same sample multiple as in the summing, the new samples are uncorrelated with each other. This provides a diversity gain. Further, the synchronisation time becomes shorter because signal energy is not spread to a wider band than before summing. The time also becomes shorter because the uncertainty region during examination becomes smaller owing to the re-sampling.

### BRIEF DESCRIPTION OF THE FIGURES

The invention will now be described in greater detail by means of preferred embodiments, with reference to the attached drawings, in which

FIG. 1 shows a synchronisation solution of prior art,

FIG. 2 illustrates multipath propagation of a signal,

FIG. 3 shows an example of a system according to an embodiment of the invention,

FIG. 4 shows a second example of a system according to an embodiment of the invention,

FIGS. 5a to 5d illustrate examples of implementations of preferred embodiments of the invention, and

FIGS. 6a and 6b illustrate a signal in different parts of receivers.

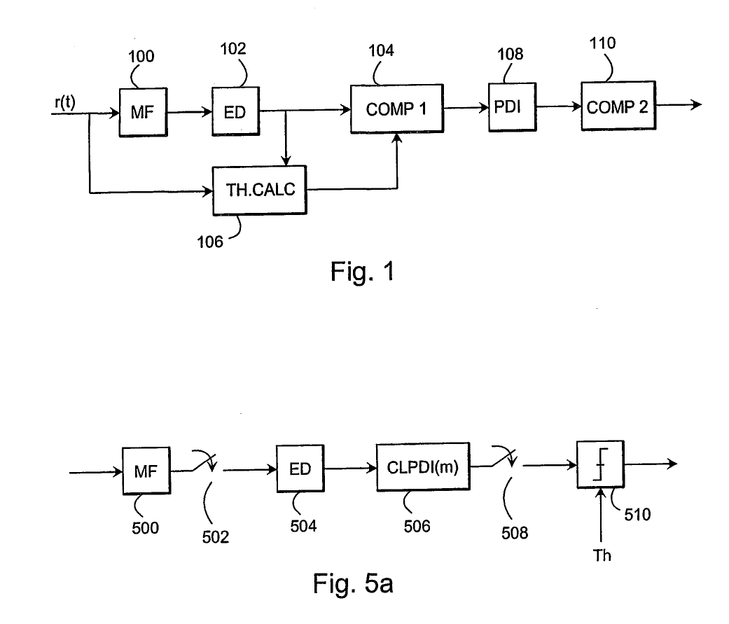

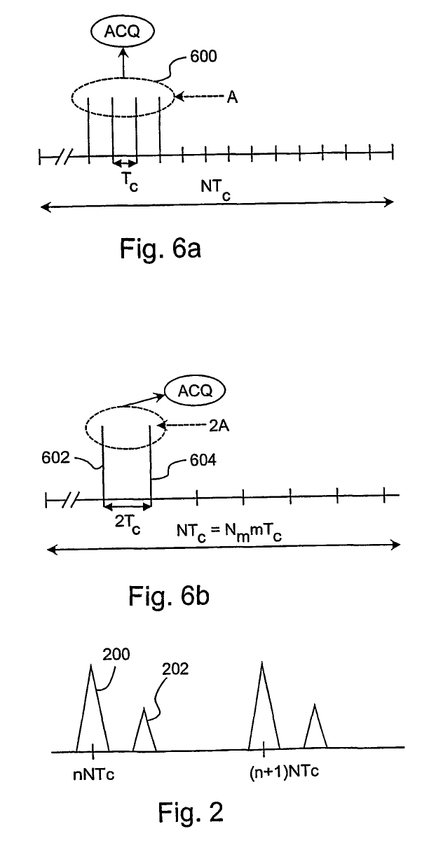

### DETAILED DESCRIPTION OF THE INVENTION

Preferred embodiments of the invention can be applied to telecommunications systems which employ spread-spectrum data transmission. One such telecommunications system is the wide band CDMA/WCDMA radio system. The following example describes preferred embodiments of the invention in a universal mobile system employing the wide band code division multiple access method, without restricting the invention to it, however.

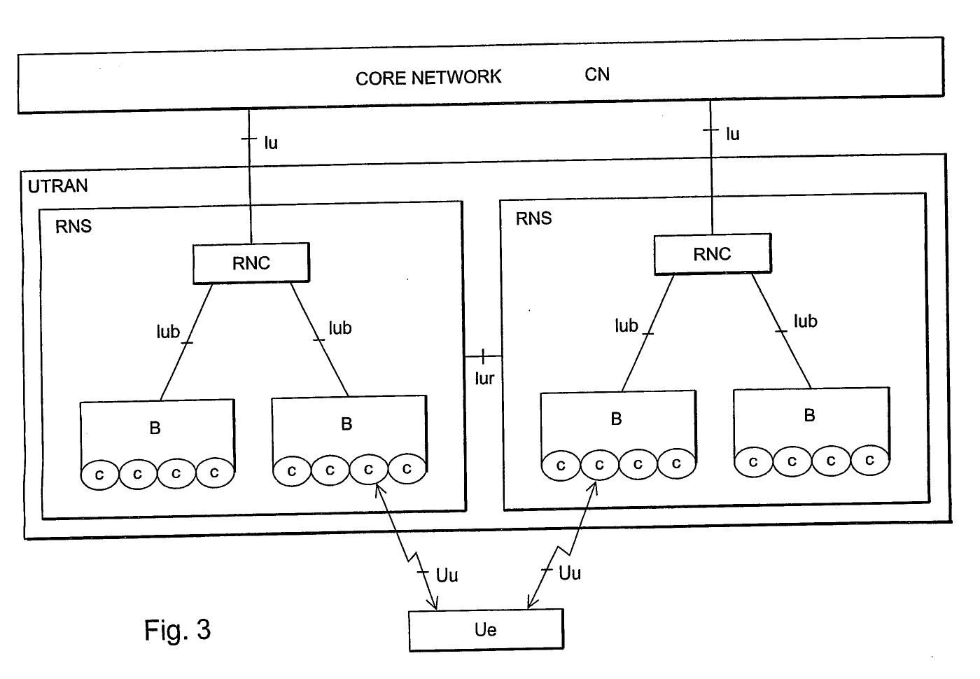

The structure of a mobile system is described by way of example with reference to FIG. 3. The main parts of a mobile system are a core network CN, a UMTS terrestrial radio access network UTRAN and user equipment UE. The interface between CN and UTRAN is called Iu and the air interface between UTRAN and UE is called Uu.

UTRAN is made up of radio network subsystems RNS. The interface between RNSs is called Iur. RNS is made up of radio network controllers RNC and one or more nodes B. The interface between RNC and B is called lub. The service area, i.e. cell, of a node B is marked C in the figure.

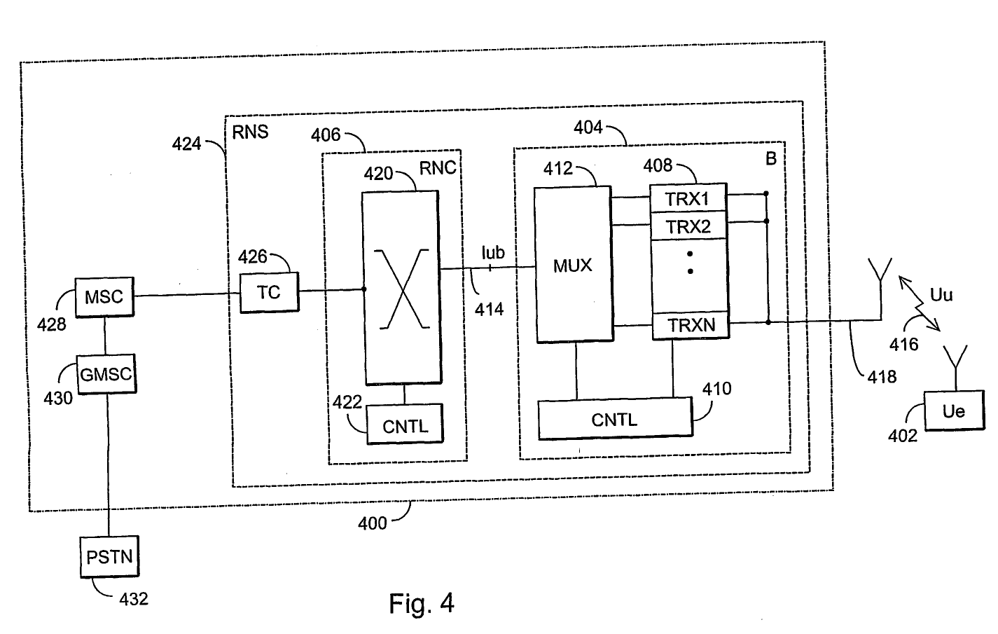

The description in FIG. 3 is a general one, so it is clarified by a more detailed example of a cellular system shown in FIG. 4. FIG. 4 only shows the most essential blocks, but it is clear to a person skilled in the art that a conventional cellular network also contains other functions and structures which need not be described in more detail herein. It should also be noted that FIG. 4 only shows an exemplary structure. In systems according to the invention, the details may differ from what is shown in FIG. 4, but these differences are not significant for the invention.

A cellular network thus typically comprises a fixed network infrastructure, i.e. network part, 400 and user equipment 402 which can be a fixed terminal, a terminal installed in a vehicle or a portable terminal. The network part 400 has base stations 404. A base station corresponds to a node B of the previous figure. A radio network controller 406 connected to several base stations 404 controls the base stations in a centralised manner. A base station 404 has transceivers 408 and a multiplexing unit 412.

A base station 404 further has a control unit 410 which controls the operation of the transceivers 408 and multiplexer 412. The traffic and control channels used by several transceivers 408 are placed by the multiplexer 412 on one transmission link 414. The transmission link 414 forms an interface lub.

The transceivers 408 of the base station 404 are connected to an antenna unit 418, with which a bi-directional radio link 416 is provided to the user equipment 402. The structure of frames transmitted over the bi-directional radio link 416 is defined separately for each system, and it is called an air interface Uu.

The radio network controller 406 comprises a group switching field 420 and a control unit 422. The group switching field 420 is used for switching speech and data and for connecting signalling circuits. A radio network subsystem 424 formed by the base station 404 and the radio network controller 406 also comprises a transcoder 426. The transcoder 426 is usually located as close as possible to a mobile switching centre 428, because speech can then be transmitted in cellular network format between the transcoder 426 and radio network controller 406, thus saving transmission capacity.

The transcoder 426 converts different digital speech coding formats used between a public switched telephone network and a radio network to suit each other, for instance from a fixed network format to a cellular network format and vice versa. The control unit 422 takes care of call control, mobility management, collection of statistics, and signalling.

FIG. 4 shows a mobile switching centre 428 and a gateway mobile switching centre 430 which manages the connections of the mobile system to the outside world, herein to a public switched telephone network 432.

Even though the above only describes the structure of the base station, the solution according to the preferred embodiments of the invention can be applied to both a base station receiver and a user equipment receiver.

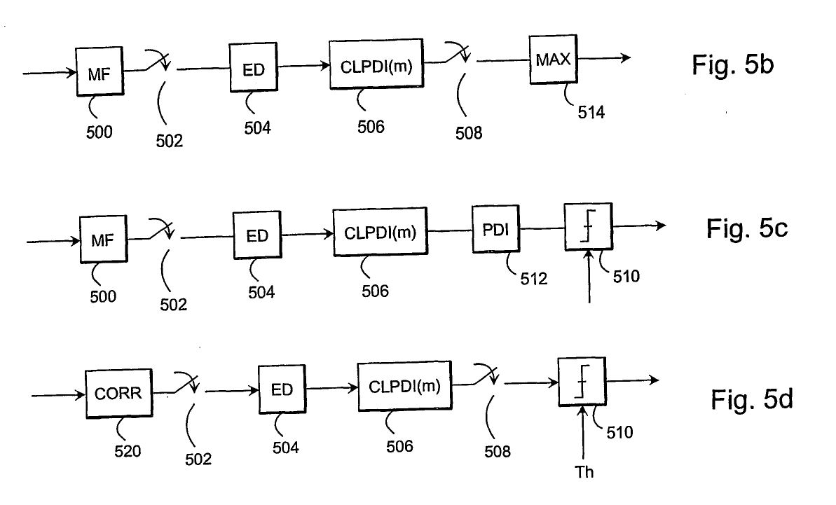

Let us now examine the structure of an arrangement according to a preferred embodiment of the invention by means of the block diagram of FIG. 5a. A received signal r(t) is forwarded to a matched filter 500, the output of which is in proportion to the auto-correlation function of the used code. Sampling means 502 take samples from the output of the matched filter at time instants nTc, wherein Tc is the length of a code chip. The samples are forwarded to an envelope detector 504. From the envelope detector, the signal is forwarded to summing means 506 which combine m consecutive samples, wherein m is higher than or equals two. This is thus a chip-level combination. The combination can be done by a suitable filter, such as FIR filter. Other methods exist, as is clear to a person skilled in the art. Second sampling means 508 take samples from the output signal of the summing means as multiples of mTc. The samples are forwarded to a threshold detector 510 which also receives a suitable threshold value Tₕ as input. The threshold value can be set by known means, for instance in a control processor (not shown in the figure). The output of the threshold detector is the value 1, if the threshold is exceeded, and otherwise 0. If the threshold is exceeded when the auto-correlation delay is 0, the detection is a correct detection, i.e. a correlation peak, whose probability is P_{d} otherwise it is a false alarm, whose probability is P_{fa}. The sampling means 502 and 508 can be implemented according to prior art.

FIG. 5b shows an arrangement according to a second preferred embodiment, which is otherwise similar to the previous one, but here the threshold detector is replaced by a maximum calculation means 514. The means define the highest value of the samples that is assumed to be the correlation peak. The calculation means 514 can be implemented by known methods.

FIG. 5c shows an arrangement of a third preferred embodiment, which is otherwise similar to the previous one, but here a bit-level combination 512 of prior art is done after the chip-level combination 506. This solution provides the advantage that it improves the signal-to-noise ratio. A bit-level combination can also be done before the chip-level combination.

FIG. 5d shows an arrangement of a preferred embodiment, which is otherwise similar to the one shown in FIG. 5a, but the matched filter 500 is replaced by a correlator 520. The basic solution of the invention can also be applied to the cases in FIGS. 5b and 5c by replacing the matched filter by a correlator. The correlator calculates a correlation with m consecutive code phases, combines the results into one variable, after which the calculation is done for the next m samples.

FIG. 6a illustrates a signal in the output of a matched filter 500 in a case where the received signal comprises four equally strong multipath propagated components 600 a chip length Tc apart from each other. The horizontal axis thus shows the time and the height of the peak shows its energy. The length of the code period is NTc. If we assume that a summing means 504 sums two consecutive samples, i.e. m=2, then FIG. 6b illustrates the output signal of the summing means 504 sampled as multiples of 2Tc. Two peaks 602, 604 that are higher than earlier are then obtained. The first peak 602 has the two first peaks from the output 600 of the matched filter summed into it, and the second peak 604 has the two latter peaks from the output 600 of the matched filter summed into it.

When the peaks have been found, a second sweep must be done over the peaks to specify the location of the peaks and to define their strength. Consecutive samples from the output of the summing means are uncorrelated. The solution of the invention thus provides a diversity gain. Because the sampling after the summing means is done using the same multiple m as the summing means, signal energy does not spread to a wider band than before the summing. This is why the second sweep can be made narrower than in earlier solutions utilising chip-level integration. Because less samples arrive at the threshold comparator than in earlier methods, the uncertainty region is smaller as regards the search. Because of this, the search time becomes shorter. The synchronisation time is thus shorter than in earlier solutions.

Even though the invention has been explained in the above with reference to examples in accordance with the accompanying drawings, it is obvious that the invention is not restricted to them but can be modified in many ways within the scope of the inventive idea disclosed in the attached claims.

1. A method for improving synchronisation, which comprises
receiving a signal,
filtering the received signal by a matched filter (500),
characterized in that the method further comprises
combining and re-sampling two or more consecutive samples in the output of the matched filter in such a manner that the re-sampling is done over as many samples as the combining, and
finding one or more correlation peaks in the combined samples.

2. A method for improving synchronisation, which comprises
receiving a signal,
filtering the received signal by a correlator (520),
characterized in that the method further comprises
combining and re-sampling two or more consecutive samples in the output of the correlator in such a manner that the re-sampling is done over as many samples as the combining, and
finding one or more correlation peaks in the combined samples.

3. A method as claimed in claim 1 or 2, characterized in that the samples are combined by means of FIR filtering.

4. A method as claimed in claim 1 or 2, characterized in that when combining m samples, the re-sampling is done over mTc samples, wherein Tc is the length of a code bit.

5. A method as claimed in claim 1, characterized in that after the matched filter, a bit-level summing is also done.

6. A method as claimed in claim 1 or 2, characterized in that the correlation peak is found by means of threshold detection.

7. A method as claimed in claim 1 or 2, characterized in that the correlation peak is found by means of maximum level detection.

8. A receiver which comprises
a matched filter (500) for filtering a received signal, and means (502) for sampling the output signal of the matched filter, means (506) for combining two or more consecutive samples,
characterized in that the receiver comprises
means (508) for re-sampling a summed signal over as many samples as were combined, and
means (510, 514) for finding one or more correlation peaks in the combined and re-sampled signal,

9. A receiver which comprises
a correlator (520) for correlating a received signal, and means (502) for sampling the output signal of the correlator, means (506) for combining two or more consecutive samples,
characterized in that the receiver comprises
means (508) for re-sampling a summed signal over as many samples as were combined, and
means (510, 514) for finding one or more correlation peaks in the combined and re-sampled signal.

10. A receiver as claimed in claim 8 or 9, characterized in that the combination means (506) are implemented by means of a FIR filter.

11. A receiver as claimed in claim 8 or 9, characterized in that the receiver further comprises means (512) for performing a bit-level combination.

12. A receiver as claimed in claim 8 or 9, characterized in that the means for finding the correlation peak location are implemented by means of a threshold detector (510).

13. A receiver as claimed in claim 8 or 9, characterized in that the means for finding the correlation peak location are implemented by means of a maximum level detector (514).

14. A receiver as claimed in claim 8 or 9, characterized in that the receiver further comprises means (512) for performing a bit-level combination.

15. A receiver as claimed in claim 8 or 9, characterized in that the receiver is a base station receiver of a cellular system.

16. A receiver as claimed in claim 8 or 9, characterized in that the receiver is a user equipment receiver of a cellular system.
